(19) United States
(12) Patent Application Publication
(10) Pub. No.: US 2016/0348595 A1
(43) Pub. Date: Dec. 1, 2016

(54) CONTROL DEVICE FOR INTERNAL COMBUSTION ENGINE AND METHOD FOR ESTIMATING COMPRESSION RATIO

(71) Applicant: HITACHI AUTOMOTIVE SYSTEMS, LTD., Hitachinaka-shi (JP)

(72) Inventor: Akira KIYOMURA, Isesaki-shi (JP)

(73) Assignee: HITACHI AUTOMOTIVE SYSTEMS, LTD., Hitachinaka-shi (JP)

(21) Appl. No.: 15/105,720

(22) PCT Filed: Dec. 19, 2014
(86) PCT No.: PCT/JP2014/083765

§ 371 Date: Jun. 17, 2016

(30) Foreign Application Priority Data
Dec. 19, 2013 (JP) 2013-262189

(51) Int. Cl. F02D 15/04; F02D 41/02; F02D 35/02; F02P 5/145; F02P 5/04

(52) U.S. Cl. CPC F02D 15/04; F02P 5/145; F02P 5/045; F02D 35/027; F02D 41/0205

(57) ABSTRACT

The present invention relates to a control device capable of estimating a compression ratio and a method for estimating a compression ratio in an internal combustion engine provided with a variable compression ratio mechanism. If an input error of a detection value of a compression ratio based on an output of a sensor occurs (S101), an engine control unit cuts off the supply of power to an actuator of the variable compression ratio mechanism (S102), and advances an ignition timing until a knock intensity reaches a set value in the process of the compression ratio decreasing due to a firing pressure (S103). Then, the engine control unit estimates the compression ratio based on the ignition timing at which the knock intensity has reached the set value (S105 and S106), and changes the variable range of the valve timing in a variable valve timing mechanism based on the estimated compression ratio.

### TECHNICAL FIELD

The present invention relates to a control device for an internal combustion engine provided with a variable compression ratio mechanism capable of changing a compression ratio, and a method for estimating a compression ratio.

### BACKGROUND ART

Patent Document 1 describes an ignition control device adapted to correct a basic ignition timing according to the change speed of a compression ratio in an internal combustion engine provided with a variable compression ratio mechanism.

### REFERENCE DOCUMENT LIST

### Patent Document

Patent Document 1: Japanese Patent Publication No. 4400116

### SUMMARY OF THE INVENTION

### Problems to be Solved by the Invention

In an internal combustion engine in which various types of control are performed according to a result of detection by a sensor of a compression ratio that can be changed by a variable compression ratio mechanism, an input error of a compression ratio detection result caused by, for example, a failure of the sensor or a failure of a communication function for transmitting and receiving sensor detection values between control units leads to a problem in that the internal combustion engine is controlled to a state that is unsuited to an actual compression ratio or the internal combustion engine is controlled to the side of caution, leading to deteriorated performance of the internal combustion engine.

The present invention has been made in view of the problems described above, and it is an object of the invention to provide a control device capable of estimating a compression ratio and a method for estimating a compression ratio in an internal combustion engine provided with a variable compression ratio mechanism.

### Means For Solving the Problems

To this end, a control device according to the present invention has an estimating unit, which estimates a compression ratio based on the correlation between an ignition timing and a knock intensity.

Further, a method for estimating a compression ratio according to the present invention includes a step of advancing an ignition timing of an internal combustion engine, a step of detecting a knock intensity, a step of detecting that the knock intensity has reached a set value, and a step of estimating a compression ratio based on an ignition timing at which the knock intensity reaches a set value.

### Effects of the Invention

According to the invention described above, a compression ratio can be estimated based on the fact that the correlation between an ignition timing and a knock intensity changes at different compression ratios.

### BRIEF DESCRIPTION OF THE DRAWINGS

FIG. 1 is a system chart of an internal combustion engine according to an embodiment of the present invention;

FIG. 2 is a flowchart illustrating the flow of the processing for estimating a compression ratio in the embodiment of the present invention;

FIG. 3 is a chart illustrating the correlation between the compression ratio and an ignition timing at which a knock intensity reaches a set value in the embodiment of the present invention; and

FIG. 4 is a time chart illustrating the changes in actual compression ratio and phase conversion angle (valve timing) when a compression ratio detection system in the embodiment of the present invention fails.

### MODE FOR CARRYING OUT THE INVENTION

The following will describe an embodiment of the present invention.

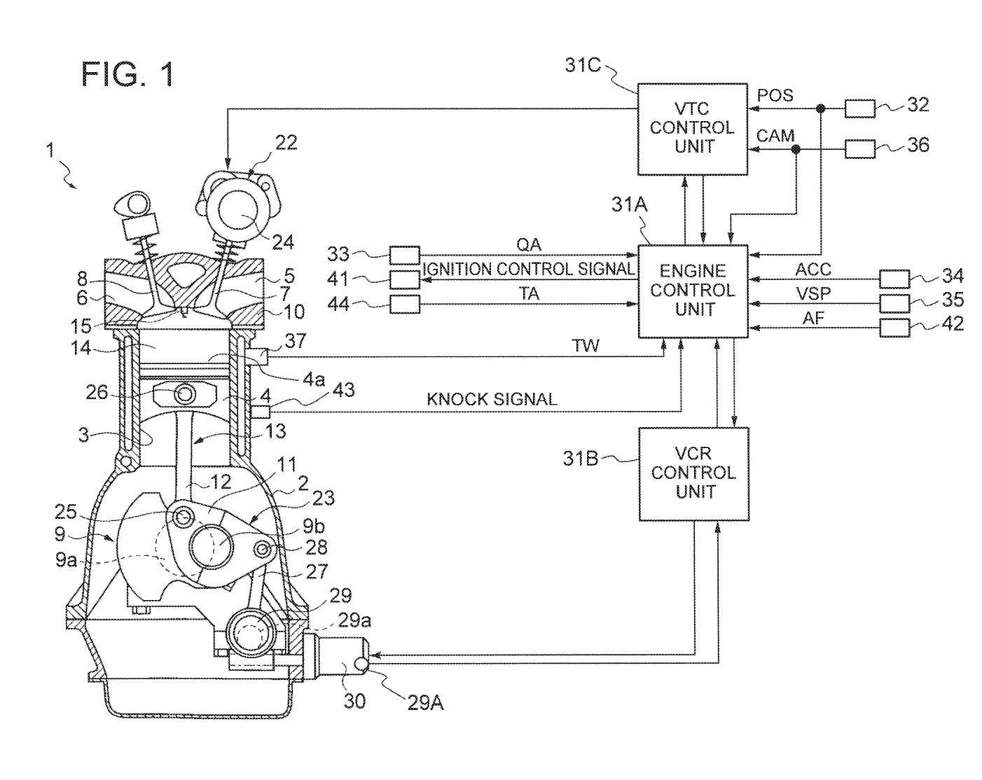

FIG. 1 illustrates an example of a vehicle internal combustion engine to which the control device and the method for estimating a compression ratio according to the present invention are applied.

An internal combustion engine 1 includes a cylinder block 2, a piston 4 provided in a cylinder bore 3 formed in cylinder block 2, a cylinder head 10 in which an intake port 5 and an exhaust port 6 are formed, and a pair of intake valves 7, 7 and a pair of exhaust valves 8, 8 per cylinder, which open and close the opening end of intake port 5 and the opening end of exhaust port 6, respectively.

Piston 4 is connected to a crankshaft 9 through the intermediary of a connecting rod 13 composed of a lower link 11 and an upper link 12.

Further, a combustion chamber 14 is formed between the crown surface 4a of piston 4 and the bottom surface of cylinder head 10. An ignition plug 15 is provided substantially at the center of cylinder head 10, which forms combustion chamber 14.

Ignition plug 15 receives a high voltage from an ignition coil 41 and performs spark discharge to ignite an air-fuel mixture. The ignition timing is controlled by controlling the timing at which the high voltage is supplied from ignition coil 41.

Further, internal combustion engine 1 includes a valve timing control mechanism (VTCS) 22 capable of changing the phase with respect to crankshaft 9 during an opening period of intake valves 7, 7 and a variable compression ratio mechanism (VCRS) 23 capable of changing the compression ratio by changing the position of the top dead center of piston 4.

Valve timing control mechanism 22, which is a variable valve mechanism, is a mechanism that changes the phase of an intake camshaft 24 with respect to crankshaft 9 thereby to continuously advance or retard the central phase of an operating angle while maintaining the operating angles of intake valves 7, 7 constant.

As valve timing control mechanism 22, an electric valve timing control mechanism adapted to adjust the relative rotational phase angle of intake camshaft 24 with respect to crankshaft 9 disclosed in, for example, Japanese Patent Application Laid-Open No. 2013-036391, can be used.

However, valve timing control mechanism 22 is not limited to a mechanism having an electric motor as an actuator, and may appropriately adopt a publicly known mechanism using a hydraulic actuator or the like.

Variable compression ratio mechanism 23 functions to change the compression ratio of internal combustion engine 1 by changing the position of the top dead center of piston 4 by a structure described in, for example, Japanese Patent Application Laid-Open No. 2002-276446.

An example of the structure of variable compression ratio mechanism 23 will be described below.

Crankshaft 9 includes a plurality of journals 9a and crankpins 9b, the journals 9a being rotatably supported by a main bearing of cylinder block 2.

Crankpins 9b are eccentric in relation to journals 9a, and lower link 11 is rotatably connected thereto.

Lower link 11 is composed of two split segments, crankpins 9b being fitted into a connection hole provided substantially at the center.

Upper link 12 has a lower end thereof rotatably connected to one end of lower link 11 by a connection pin 25, and an upper end thereof rotatably connected to piston 4 by a piston pin 26.

A control link 27 has an upper end thereof rotatably connected to the other end of lower link 11 by a connection pin 28, and a lower end thereof rotatably connected to the bottom of cylinder block 2 through the intermediary of a control shaft 29.

Specifically, control shaft 29 is rotatably supported by an internal combustion engine main body (cylinder block 2), and has an eccentric cam 29a, which is eccentric with respect to the center of rotation thereof. A lower end of control link 27 is rotatably fitted to eccentric cam 29a.

The rotational position of control shaft 29 is controlled by a compression ratio control actuator 30, which uses an electric motor.

In variable compression ratio mechanism 23, which uses the double-link type piston crank system as described above, when control shaft 29 is rotated by compression ratio control actuator 30, the relative position with respect to the position of center of eccentric cam 29a, i.e. cylinder block 2, changes.

Therefore, the rocking support position of the lower end of control link 27 is changed and the rocking support position of control link 27 is changed, causing the stroke of piston 4 to change. This in turn causes the position of piston 4 at the top dead center to be raised or lowered, thus changing the compression ratio of internal combustion engine 1. In other words, the position of piston 4 at the top dead center changes according to the angular position of control shaft 29, thus changing the compression ratio of internal combustion engine 1.

Ignition coil 41 and a fuel injection valve, which is not illustrated, are controlled by an engine control unit 31A, variable compression ratio mechanism 23 is controlled by a VCR control unit 31B, and valve timing control mechanism 22 is controlled by a VTC control unit 31C.

Engine control unit 31A, VCR control unit 31B, and VTC control unit 31C include microcomputers and are connected to be capable of intercommunication through a CAN (Controller Area Network).

Further, engine control unit 31A calculates a desired compression ratio of variable compression ratio mechanism 23 and a desired phase conversion angle of valve timing control mechanism 22 according to the operation state of internal combustion engine 1, transmits the data of the desired compression ratio to VCR control unit 31B and transmits the data of the desired phase conversion angle to VTC control unit 31C.

The desired phase conversion angle corresponds to a desired advance value of the valve timing of intake valves 7, 7.

VCR control unit 31B receives the data of the desired compression ratio output by engine control unit 31A, i.e. the data of the desired angular position of control shaft 29. VCR control 31B also receives the angular position of control shaft 29, i.e. an output signal of an angle sensor 29A, which detects an actual compression ratio.

Then, VCR control unit 31B calculates a manipulated variable of actuator 30 that will bring the angular position of control shaft 29 detected by angle sensor 29A close to the desired angular position corresponding to the desired compression ratio, and outputs the calculated manipulated variable. In other words, VCR control unit 31B performs compression ratio feedback control.

Further, VTC control unit 31C receives the data of the desired phase conversion angle output by engine control unit 31A. VTC control unit 31C also receives a crank angle signal POS output by a crank angle sensor 32, which detects the angular position of crankshaft 9, and a cam angle signal CAM output by a cam angle sensor 36, which detects the angular position of intake camshaft 24.

Then, VTC control unit 31C detects the relative rotational phase angle of intake camshaft 24 with respect to crankshaft 9 based on the crank angle signal POS and the cam angle signal CAM, and calculates the manipulated variable of the actuator of valve timing control mechanism 22 to bring the detected relative rotational phase angle close to the desired phase conversion angle and then output the calculated manipulated variable. In other words, VTC control unit 31C performs the feedback control of the valve timings of intake valves 7, 7.

Meanwhile, VCR control unit 31B outputs the information on the angular position of control shaft 29 detected based on the output of angle sensor 29A, i.e. the information on the actual compression ratio, to engine control unit 31A. Further, VTC control unit 31C outputs the information on the relative rotational phase angle of intake camshaft 24 with respect to crankshaft 9, which is detected based on the output of crank angle sensor 32 and the output of cam angle sensor 36, to engine control unit 31A.

The output of crank angle sensor 32 and the output of cam angle sensor 36 are input to both engine control unit 31A and VTC control unit 31C. Further, the output of angle sensor 29A can be input to both engine control unit 31A and VCR control unit 31B.

Engine control unit 31A also receives the signals output by various sensors, such as an airflow sensor 33 that detects an intake airflow QA of internal combustion engine 1, an accelerator opening sensor 34 that detects an accelerator opening ACC, which is an accelerator pedal depression amount, a vehicle speed sensor 35 that detects a traveling speed VSP of a vehicle in which internal combustion engine 1 is installed, a water temperature sensor 37 that detects the temperature of cooling water TW of internal combustion engine 1, an air-fuel ratio sensor 42 that detects the concentration of oxygen in exhaust correlated to the air-fuel ratio of internal combustion engine 1, and a knock sensor 43 that detects the vibration attributable to knocking.

Here, in the processing for setting a desired phase conversion angle, engine control unit 31A sets a limit value on the advancing side of the desired phase conversion angle based on the information on an actual compression ratio and sets the desired phase conversion angle within a range not exceeding the limit value on the advancing side.

In a state wherein the compression ratio is high, which leads to a high position of piston 4 at the top dead center, an interference between piston 4 and intake valve 7 may occur if the valve lift amount at the top dead center increases by advancing the valve timing of intake valve 7.

Thus, engine control unit 31A changes the variable range of the phase conversion angle of valve timing control mechanism 22 according to the compression ratio, which can be changed by variable compression ratio mechanism 23, so as to prevent the occurrence of the interference between piston 4 and intake valve 7.

More specifically, engine control unit 31A changes the limit value of the advance side of the valve timing of intake valve 7 further to a retard side as the compression ratio changed by variable compression ratio mechanism 23 increases, thereby preventing the change of the valve timing to the advance side from being unduly restricted while preventing the occurrence of the interference between piston 4 and intake valve 7.

Engine control unit 31A acquires the actual value of the compression ratio that can be changed by variable compression ratio mechanism 23, i.e. the detection result of the compression ratio given by angle sensor 29A, from VCR control unit 31B through a communication line, such as CAN (Controller Area Network).

Hence, engine control unit 31A can no longer properly set the variable range of the valve timing if an input error of compression ratio detection value occurs due to a failure of angle sensor 29A, CAN communication circuit, VCR control unit 31B, or the like.

If an input error of a compression ratio detection value occurs, therefore, engine control unit 31A estimates an actual compression ratio from an operation state of internal combustion engine 1 and changes the variable range of the valve timing according to the estimated value.

This arrangement enables engine control unit 31A to change, as quickly as possible, a desired phase conversion angle of valve timing control mechanism 22 to the advance side within the range, in which the interference between piston 4 and intake valve 7 does not occur, even if a compression ratio detection result become no longer available from angle sensor 29A. Hence, in case of an input error of a compression ratio detection value, the occurrence of valve interference can be prevented, thus preventing deterioration of the operation performance of internal combustion engine 1.

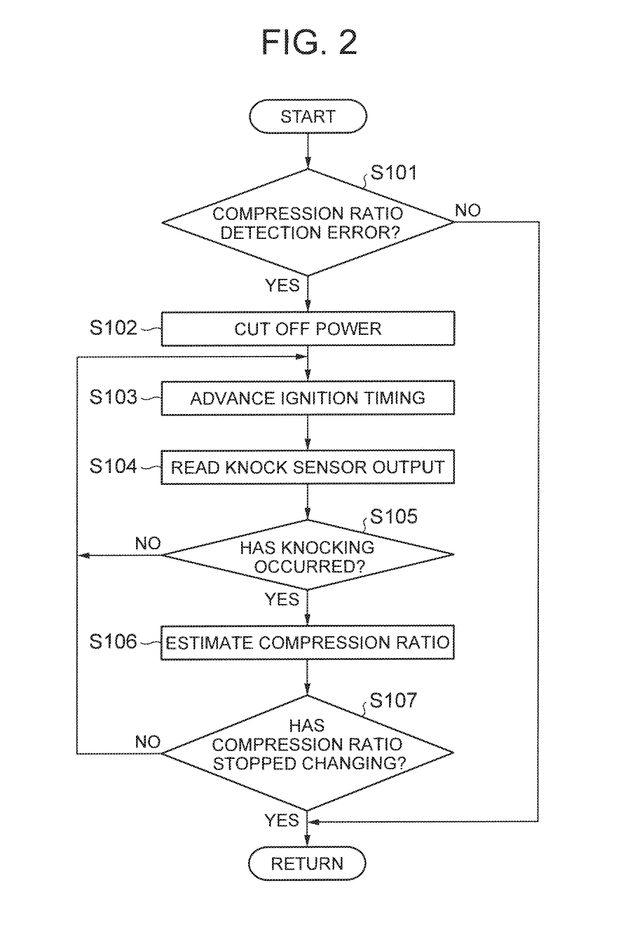

The following will describe in detail the processing for estimating a compression ratio carried out by engine control unit 31A according to the flowchart of FIG. 2.

The routine illustrated in the flowchart of FIG. 2 is executed by engine control unit 31A in a time interrupt processing.

In step S101, engine control unit 31A determines whether an input error of a compression ratio detection result supplied by angle sensor 29A has occurred.

Specifically, engine control unit 31A determines whether an error has occurred in the communication with VCR control unit 31B. Further, engine control unit 31A determines whether a diagnosis signal announcing the failure of angle sensor 29A has been transmitted from VCR control unit 31B.

If engine control unit 31A directly receives an output signal of angle sensor 29A, then engine control unit 31A mainly determines whether the failure of angle sensor 29A is being diagnosed.

Then, based on the foregoing determination result, engine control unit 31A detects whether the compression ratio detection result supplied by angle sensor 29A can be used for setting a desired phase conversion angle or the like.

If angle sensor 29A, CAN communication circuit, VCR control unit 31B and the like are normal and the input of the compression ratio detection result supplied by angle sensor 29A are normal, then engine control unit 31A can carry out the processing for restricting the desired phase conversion angle according to the compression ratio detected based on the output of angle sensor 29A, thus eliminating the need for the processing for estimating the compression ratio. Thus, if angle sensor 29A, CAN communication circuit, VCR control unit 31B and the like are normal, engine control unit 31A terminates the routine without proceeding to the processing in step S102 and after.

Meanwhile, if an error occurs in angle sensor 29A, CAN communication circuit, VCR control unit 31B and the like, leading to the input error of the compression ratio detection result supplied by angle sensor 29A, then engine control unit 31A proceeds to step S102.

In step S102, engine control unit 31A cuts off the supply of power to actuator 30 of variable compression ratio mechanism 23. In other words, engine control unit 31A stops the control of actuator 30.

If VCR control unit 31B is normal, then the supply of power to actuator 30 can be cut off by engine control unit 31A outputting a command to VCR control unit 31B to cut off the power supply. However, if VCR control unit 31B fails, then the supply of power to actuator 30 may not actually be cut off even when engine control unit 31A outputs the command to VCR control unit 31B.

Therefore, a relay provided on a power line through which power is supplied to actuator 30 is configured to turn off when an OFF command is output from at least one of engine control unit 31A and VCR control unit 31B and to turn on when an ON command is output from both of engine control unit 31A and VCR control unit 31B.

This arrangement enables VCR control unit 31B to independently cut off the supply of power to actuator 30 if VCR control unit 31B diagnoses a failure of angle sensor 29A, or enables engine control unit 31A to independently cut off the supply of power to actuator 30 if a communication failure prevents engine control unit 31A from acquiring the information of the compression ratio whereas angle sensor 29A is normal.

A firing pressure acts in a direction to press down the position of piston 4 at the top dead center. Therefore, when the supply of power to actuator 30 of variable compression ratio mechanism 23 is cut off and actuator 30 no longer generates torque, the compression ratio that can be changed by variable compression ratio mechanism 23 decreases.

In other words, if the information of the compression ratio can be no longer acquired, engine control unit 31A cuts off the supply of power to actuator 30 so as to decrease the compression ratio, thereby preventing internal combustion engine 1 from being operated at an excessively high compression ratio.

After cutting off the supply of power to actuator 30, engine control unit 31A proceeds to step S103 to gradually advance the ignition timing by ignition plug 15 from the ignition timing in the normal state in which the information of the compression ratio was obtained.

Then, engine control unit 31A reads an output of knock sensor 43 in step S104, and determines based on an output of knock sensor 43 in step S105 whether knocking has occurred, i.e. whether the knock intensity has exceeded a set value.

If engine control unit 31A determines that the knock intensity is lower than the set value and therefore no knocking is occurring, then engine control unit 31A returns to step S103 to continue the control for advancing the ignition timing thereby to further advance the ignition timing.

Meanwhile, if engine control unit 31A detects a knocking occurrence state in which the knock intensity exceeds the set value, then engine control unit 31A proceeds to step S106 to estimate the compression ratio based on the ignition timing at that time, i.e. the ignition timing at which a predetermined knock intensity was reached.

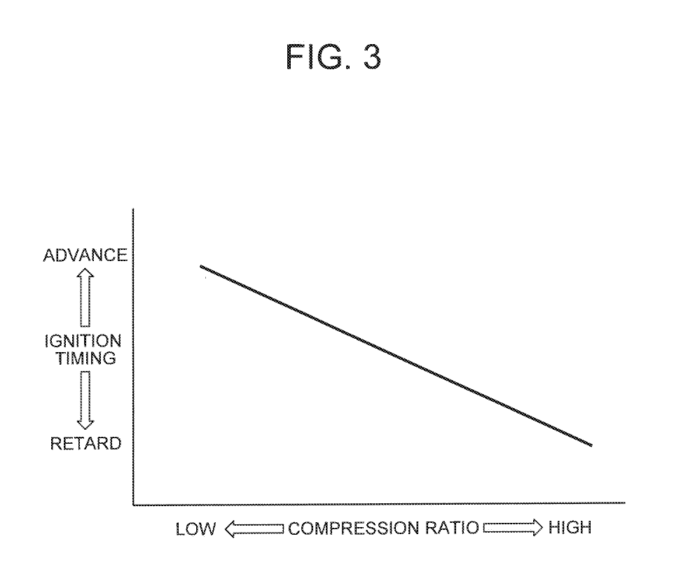

The correlation between the knock intensity and the ignition timing changes according to the compression ratio. As illustrated in FIG. 3, the ignition timing at which the predetermined knock intensity is reached advances as the compression ratio decreases.

Hence, the compression ratio can be estimated from the ignition timing at which the predetermined knock intensity is reached when the ignition timing is advanced.

Cutting off the supply of power to actuator 30 causes the actual compression ratio to be gradually decreased by the firing pressure. As the compression ratio is decreased, the ignition timing at which the predetermined knock intensity is reached gradually changes to the advance side, and the estimation result of the compression ratio will also gradually change toward a further lower compression ratio.

Even if the compression ratio remains the same, the ignition timing at which the predetermined knock intensity is reached changes according to an intake air temperature and/or a fuel property, such as an octane rating, at that time. For this reason, engine control unit 31A can correct the estimation result of the compression ratio based on the ignition timing according to an intake air temperature and/or a fuel property.

More specifically, knocking occurs more easily as an intake air temperature increases, so that engine control unit 31A changes the estimation result of the compression ratio based on the ignition timing, at which the predetermined knock intensity is reached, to a lower value as the intake air temperature increases.

Further, a higher octane rating of a fuel reduces the occurrence of knocking, so that engine control unit 31A changes the estimation result of the compression ratio based on the ignition timing, at which the predetermined knock intensity is reached, to a higher value as the octane rating increases.

Thus, it is possible to prevent the accuracy of the estimation of the compression ratio from deteriorating even when the intake air temperature and/or the octane rating of a fuel changes.

Engine control unit 31A can acquire the information of intake air temperature TA from an output of an intake air temperature sensor 44. Further, engine control unit 31A can determine the information of the octane rating of a fuel based on the ignition timing, at which the predetermined knock intensity is reached, and the detection value of the compression ratio in a state in which angle sensor 29A is normal and the detection result of the compression ratio can be obtained.

Further, engine control unit 31A has a correlation table of ignition timing vs. compression ratio for each intake air temperature and also a correlation table of ignition timing vs. compression ratio for each octane rating, and can select a table to refer to according to the condition of the intake air temperature or the octane rating so as to estimate the compression ratio based on a selected table.

Further, engine control unit 31A can learn beforehand the characteristic in that the ignition timing, at which the predetermined knock intensity is reached, changes according to the intake air temperature and/or the octane rating at the time while angle sensor 29A is normal and the detection value of the compression ratio is normally input.

After estimating the compression ratio in step S106, engine control unit 31A proceeds to step S107 to determine whether a varying estimation result of the compression ratio has ceased changing, i.e. whether the compression ratio that can be changed by variable compression ratio mechanism 23 has been decreased to a minimum compression ratio in a variable range by cutting off the supply of power to actuator 30.

The minimum compression ratio of the variable range of the compression ratio is an initial value or a default value of the compression ratio.

Engine control unit 31A determines that the decrease in the compression ratio has stopped if engine control unit 31A determines that the compression ratio estimated based on the ignition timing has stopped varying and/or the compression ratio estimated based on the ignition timing has reached the minimum compression ratio.

In this case, the compression ratio will be maintained at the minimum compression ratio until the supply of power to actuator 30 is resumed thereafter, so that engine control unit 31A terminates the processing for estimating the compression ratio by controlling the ignition timing to the advance side.

In other words, until the compression ratio reaches the minimum compression ratio after the supply of power to actuator 30 is stopped, engine control unit 31A repeats the processing for estimating the compression ratio based on the ignition timing, at which the predetermined knock intensity is reached, to estimate the change in an actual compression ratio until the compression ratio reaches the minimum compression ratio.

Then, engine control unit 31A sets a limit value on the advance side of the desired phase conversion angle such that the variable range of the phase conversion angle of valve timing control mechanism 22 becomes an angle range in which the interference between piston 4 and intake valve 7 will not occur under an estimated compression ratio condition. Then, engine control unit 31A places a restriction such that a desired phase conversion angle will not advance, exceeding the advance limit value, and outputs a desired phase conversion angle, which is on a retard side relative to the advance limit value, to VTC control unit 31C.

Thus, even if engine control unit 31A cannot obtain the detection data of an actual compression ratio due to, for example, a failure of angle sensor 29A, engine control unit 31A can perform control to obtain a valve timing that advances as soon as possible while preventing the occurrence of the interference between piston 4 and intake valve 7. This makes it possible to prevent the deterioration of the operation performance of internal combustion engine 1.

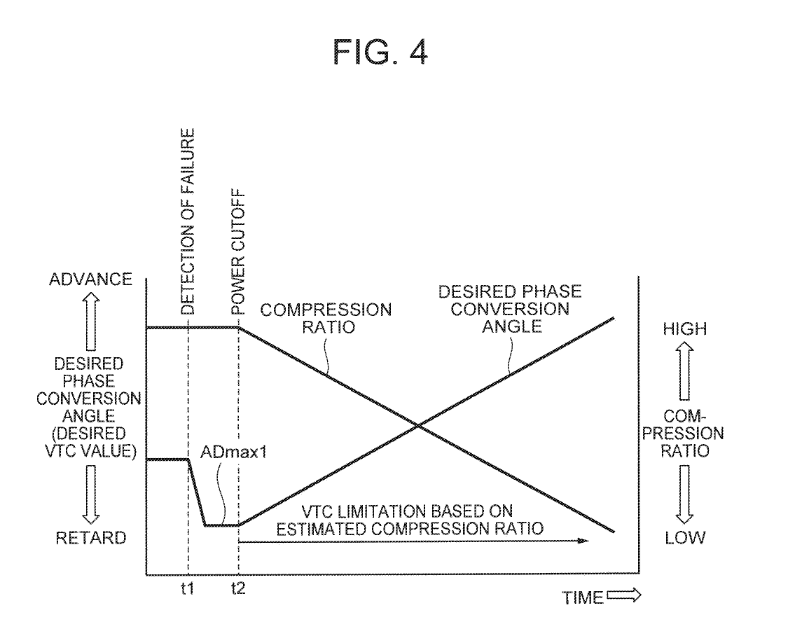

The time chart of FIG. 4 illustrates an example of changes in the compression ratio and the desired phase conversion angle when engine control unit 31A can no longer acquire compression ratio detection data.

Referring to the time chart of FIG. 4, when engine control unit 31A detects a failure that disables engine control unit 31A to acquire the compression ratio detection data at time t1, the compression ratio will be unknown until an estimated value of the compression ratio is acquired. Therefore, engine control unit 31A retards the advance limit of the phase conversion angle of valve timing control mechanism 22 to a value ADmax1 that matches the state in which the compression ratio is unknown, and sets the desired phase conversion angle to the retard side relative to the advance limit value ADmax1.

Then, when engine control unit 31A cuts off the supply of power to actuator 30 of variable compression ratio mechanism 23 at time t2, the compression ratio gradually decreases from a value obtained before the cutoff of the power supply due to the action of the firing pressure. In the process of the decrease in the compression ratio, engine control unit 31A advances the ignition timing until the knock intensity reaches a predetermined value, and estimates the actual compression ratio from the ignition timing at which the knock intensity reaches the predetermined value. The initial value of the estimated value of the compression ratio is the compression ratio detected by angle sensor 29A immediately before the detection of the failure.

When the estimation of the compression ratio is resumed, the advance limit of the phase conversion angle based on the estimated value is updated further to the advance side, so that a further advanced value can be set as the desired phase conversion angle, thus making it possible to prevent a decline of an effective compression ratio.

The details of the present invention have been described above with reference to a preferred embodiment. However, it is obvious that those skilled in the art can make a variety of modifications based on the basic technological thought and the teaching of the present invention.

If the communication between engine control unit 31A and VTC control unit 31C is being normally performed, but angle sensor 29A has failed, engine control unit 31A can transmit the data of an estimation result of the compression ratio and a desired compression ratio to VTC control unit 31C, and VTC control unit 31C can compare the estimation result of the compression ratio and the desired compression ratio to control actuator 30.

Further, in the case of an internal combustion engine provided with a valve timing control mechanism capable of changing the valve timing of an exhaust valve 8, engine control unit 31A can set the retard limit of the valve timing of exhaust valve 8 based on an estimated compression ratio and change the valve timing of exhaust valve 8 within a range that does not exceed the retard limit, thereby preventing the interference between piston 4 and exhaust valve 8.

Further, a sensor that detects the knock intensity by detecting a change in the firing pressure can be used as knock sensor 43.

Further, the value of a fuel octane rating to be used may be specified by a driver through an octane selector or the like.

Further, a single control unit that comprehensively includes the functions of engine control unit 31A, VCR control unit 31B, and VTC control unit 31C may be provided. In this case, if angle sensor 29A fails, an actual compression ratio is estimated based on the ignition timing advanced while monitoring the knock intensity.

Further, as a variable valve mechanism, a variable valve lift mechanism may be provided together with valve timing control mechanism 22, the variable valve lift mechanism being capable of continuously changing the operating angle of intake valve 7 and increasing a maximum valve lift amount as the operating angle is increased.

Further, in the case where valve timing control mechanism 22 and the variable valve lift mechanism are provided, engine control unit 31A can change the advance limit of the phase conversion angle of valve timing control mechanism 22 and/or the upper limit value of the operating angle of the variable valve lift mechanism based on an estimated compression ratio.

In the foregoing embodiment, the knock intensity has been detected by knock sensor 43. Alternatively, however, a configuration may be adopted, in which the knock intensity is estimated without using knock sensor 43 and the compression ratio is estimated.

More specifically, if the ignition timing is not changed when the compression ratio decreases due to the cutoff of the supply of power to actuator 30 of variable compression ratio mechanism 23, the rotation fluctuation of internal combustion engine 1 increases due to deteriorated combustion.

Therefore, engine control unit 31A advances the ignition timing such that the magnitude of the rotation fluctuation reduces to be smaller than a set value, thus enabling engine control unit 31A to estimate the compression ratio from the ignition timing at which the rotation fluctuation reaches the set value. In other words, engine control unit 31A can estimate the compression ratio based on the fact that the ignition timing at which stable burning performance is obtained changes according to the compression ratio.

### REFERENCE SYMBOL LIST

1 Internal combustion engine
4 Piston
7 Intake valve
15 Ignition plug
22 Valve timing control mechanism (Variable valve mechanism)
23 Variable compression ratio mechanism
29A Angle sensor
30 Actuator
31A Engine control unit
31B VCR control unit
31C VTC control unit
41 Ignition coil
43 Knock sensor

1-14. (canceled)

15. A control device for an internal combustion engine provided with a variable compression ratio mechanism capable of changing a compression ratio, the control device comprising:
an estimating unit that estimates a compression ratio based on a correlation between an ignition timing and a knock intensity,
wherein the estimating unit stops the control of an actuator of the variable compression ratio mechanism in the case of the occurrence of an input error of a detection result supplied by a sensor, which detects a compression ratio that can be changed by the variable compression ratio mechanism, changes an ignition timing in the process of a compression ratio returning to an initial value due to the stop of the control, and then estimates the compression ratio.

16. The control device for an internal combustion engine according to claim 15, wherein the estimating unit changes an estimation result of a compression ratio according to at least one of an intake air temperature and a fuel property.

17. The control device for an internal combustion engine according to claim 15, wherein the estimating unit changes the estimated value of a compression ratio to a smaller value as the temperature of intake air of the internal combustion engine increases.

18. The control device for an internal combustion engine according to claim 15, wherein the estimating unit changes the estimated value of a compression ratio to a larger value as the octane rating of a fuel of the internal combustion engine increases.

19. A method for estimating a compression ratio of an internal combustion engine provided with a variable compression ratio mechanism capable of changing a compression ratio by using a motor as an actuator, and a sensor that detects a compression ratio, the method comprising:
a step of advancing an ignition timing of the internal combustion engine;
a step of detecting a knock intensity;
a step of detecting that the knock intensity has reached a set value; and
a step of estimating the compression ratio based on an ignition timing at which the knock intensity has reached the set value,
wherein the step of advancing an ignition timing includes:
a step of detecting the presence of an error of a detection value of the sensor; and
a step of cutting off the supply of power to the motor of the variable compression ratio mechanism in the case where an error of a detection value of the sensor occurs, and advances the ignition timing in the process of the compression ratio returning to an initial value due to the cutoff of the supply of power to the motor.

20. The control device for an internal combustion engine according to claim 15,
wherein the initial value of the compression ratio is a minimum compression ratio that can be changed by the variable compression ratio mechanism, and
the estimating unit advances the ignition timing until the knock intensity reaches a set value in a period until the compression ratio reaches the minimum compression ratio, and estimates the compression ratio based on an ignition timing at which the knock intensity reaches the set value.

21. The control device for an internal combustion engine according to claim 15,
wherein the internal combustion engine includes a variable valve mechanism capable of changing the opening characteristic of an engine valve, and
the control device further includes a control unit that changes a variable range of a control amount of the variable valve mechanism based on an estimated value of a compression ratio estimated by the estimating unit.

22. The control device for an internal combustion engine according to claim 21, wherein the control unit changes a valve timing of the intake valve to an advance side within a range in which a piston of the internal combustion engine and the intake valve do not interfere with each other at a compression ratio estimated by the estimating unit.

23. The method for estimating a compression ratio of an internal combustion engine according to claim 19,
wherein the internal combustion engine includes a variable valve mechanism capable of changing the opening characteristic of an engine valve, and
the method further includes a step of changing a variable range of the control amount of the variable valve mechanism so as to prevent a piston of the internal combustion engine and the engine valve from interfering with each other at an estimated compression ratio.

24. The method for estimating a compression ratio of an internal combustion engine according to claim 23,
wherein the variable valve mechanism is a variable valve mechanism capable of changing the valve timing of an intake valve,
the initial value of the compression ratio is a minimum compression ratio that can be changed by the variable compression ratio mechanism, and
a step of changing the variable range of the control amount of the variable valve mechanism changes an advance control limit of a valve timing of the intake valve further to an advance side according to a decrease in the compression ratio estimated until the compression ratio reaches the minimum compression ratio.
